(19) United States
(12) Patent Application Publication
(10) Pub. No.: US 2026/0121839 A1
(43) Pub. Date: Apr. 30, 2026

(54) BLOCK CHAIN BASED ASYNCHRONOUS EDGE DEVICE ACTIVATION AND CLOUD REGISTRATION

(71) Applicant: Lenovo Enterprise Solutions (Singapore) Pte. Ltd., New Tech Park (SG)

(72) Inventors: Caihong Zhang, Shanghai (CN); Fred Allison Bower, III, Durham, NC (US); Jiang Chen, Shanghai (CN); Ajay Dholakia, Cary, NC (US)

(21) Appl. No.: 18/563,655

(22) PCT Filed: Jul. 12, 2023
(86) PCT No.: PCT/CN2023/106940

§ 371 Date: Nov. 22, 2023

(51) Int. Cl. H04L 9/08; G06Q 20/38

(52) U.S. Cl. CPC H04L 9/0825; G06Q 20/382

(57) ABSTRACT

A method for activation of a remote server using activation information stored as transactions in a blockchain ledger is disclosed. The method includes activating an agent on a server in response to the server being powered on for activation by an end user of the server. The agent includes a private key where the private key is paired with a public key by a manufacturer of the server. The public key is entered in a transaction of a ledger of a blockchain corresponding to the server. The ledger includes activation information for the server and the activation information is encrypted using the public key. The method includes accessing the ledger by the agent and decrypting, by the agent, the activation information using the private key. The method includes using, by the agent, the activation information to activate the server.

### TECHNICAL FIELD

The subject matter disclosed herein relates to remote server activation and more particularly relates to activation of a remote server using activation information stored as transactions in a blockchain ledger.

### BACKGROUND

When an edge device is shipped to an edge store, typically a service person needs to go to the edge site to claim and activate this edge device, install an operating system, and target cloud software stack on the server, and register the server to the target cloud to run workloads. For edge device activation, the service person at the edge site connects with an edge device activation portal such as Lenovo® ThinkShield® to claim this server, and get an activation key of this server to activate this server. For registration of the server with a cloud service, the service person needs to download device specific secrets and configuration files manually from a console of the cloud service and needs to copy the configuration files to the server, typically using a universal serial bus (“USB”) drive. A USB key is typically needed to copy and store cloud secrets and configuration files and to distribute them to a service person. Having a service person go to an end user site to activate a server is cumbersome, expensive, and time consuming.

### SUMMARY

A method for activation of a remote server using activation information stored as transactions in a blockchain ledger is disclosed. The method includes activating an agent on a server in response to the server being powered on for activation by an end user of the server. The agent includes a private key where the private key is paired with a public key by a manufacturer of the server. The public key is entered in a transaction of a ledger of a blockchain corresponding to the server. The ledger includes activation information for the server and the activation information is encrypted using the public key. The method includes accessing the ledger by the agent and decrypting, by the agent, the activation information using the private key. The method includes using, by the agent, the activation information to activate the server.

A remote server includes a processor and non-transitory computer readable storage media storing code. The code includes an agent and the code of the agent is executable by the processor to perform operations that include activating the agent in response to the server being powered on for activation by an end user of the server. The agent includes a private key where the private key is paired with a public key by a manufacturer of the server. The public key is entered in a transaction of a ledger of a blockchain corresponding to the server. The ledger includes activation information for the server. The activation information is encrypted using the public key. The operations include accessing the ledger by the agent, decrypting, by the agent, the activation information using the private key, and using, by the agent, the activation information to activate the server.

A program product for activation of a remote server using activation information stored as transactions in a blockchain ledger is disclosed includes a non-transitory computer readable storage medium storing code. The code is configured to be executable by a processor to perform operations that include activating an agent on a server in response to the server being powered on for activation by an end user of the server. The agent includes a private key where the private key is paired with a public key by a manufacturer of the server. The public key is entered in a transaction of a ledger of a blockchain corresponding to the server where the ledger includes activation information for the server. The activation information encrypted using the public key. The operations include accessing the ledger by the agent, decrypting, by the agent, the activation information using the private key, and using, by the agent, the activation information to activate the server.

### DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for activating a remote server using a ledger of a blockchain, according to various embodiments;

FIG. 2 is a schematic block diagram illustrating steps for activating a remote server using ledger of a blockchain, according to various embodiments;

FIG. 3 is a schematic block diagram illustrating an apparatus for activating a remote server using a ledger of a blockchain, according to various embodiments;

FIG. 4 is a schematic block diagram illustrating another apparatus for activating a remote server using a ledger of a blockchain, according to various embodiments;

FIG. 5 is a schematic flow chart diagram illustrating a method for activating a remote server using a ledger of a blockchain, according to various embodiments;

FIG. 6A is a first part of a schematic flow chart diagram illustrating another method for activating a remote server using a ledger of a blockchain, according to various embodiments; and

FIG. 6B is a second part of the schematic flow chart diagram of FIG. 6A.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for activation of a remote server using activation information stored as transactions in a blockchain ledger is disclosed. The method includes activating an agent on a server in response to the server being powered on for activation by an end user of the server. The agent includes a private key where the private key is paired with a public key by a manufacturer of the server. The public key is entered in a transaction of a ledger of a blockchain corresponding to the server. The ledger includes activation information for the server and the activation information is encrypted using the public key. The method includes accessing the ledger by the agent and decrypting, by the agent, the activation information using the private key. The method includes using, by the agent, the activation information to activate the server.

In some embodiments, the activation information includes an activation code and/or a cloud secret encrypted using the public key. Using the activation information to activate the server includes using, by the agent, the activation code to activate the server and/or using, by the agent, the cloud secret to register the server with a cloud service corresponding to the cloud secret. In other embodiments, the ledger includes a cloud configuration encrypted using the public key and the cloud configuration identifies the cloud secret to be used to register the server with the cloud service. In other embodiments, the agent further decrypts the cloud configuration using the private key and identifies, from the cloud configuration, the cloud secret to be used to register the server with the cloud service. In other embodiments, the activation information further includes a software authorization code encrypted by the public key and the agent downloads software activated by the software authorization code, decrypts the software authorization code using the private key, and uses the software authorization code to activate the software on the server.

In some embodiments, the ledger includes two or more transactions with a first transaction added by the manufacturer. Each of the two or more transactions is encrypted with the public key and one or more of the transactions added after the first transaction include information used by the agent to configure the server. In other embodiments, at least one of the one or more transactions added to the ledger after the first transaction is added by an entity different than the manufacturer and the entity possessed the server after the manufacturer and before the end user. In other embodiments, each of the two or more transactions in the ledger is by an entity that possessed the server when a transaction of the two or more transactions is added in the ledger.

In some embodiments, the agent is installed on the server by the manufacturer. In other embodiments, the method includes adding, by the agent, a transaction in the ledger. The transaction includes identification of the end user, information about activating the server, and/or server provisioning completement. The agent encrypts the transaction by the agent using the public key.

A remote server includes a processor and non-transitory computer readable storage media storing code. The code includes an agent and the code of the agent is executable by the processor to perform operations that include activating the agent in response to the server being powered on for activation by an end user of the server. The agent includes a private key where the private key is paired with a public key by a manufacturer of the server. The public key is entered in a transaction of a ledger of a blockchain corresponding to the server. The ledger includes activation information for the server. The activation information is encrypted using the public key. The operations include accessing the ledger by the agent, decrypting, by the agent, the activation information using the private key, and using, by the agent, the activation information to activate the server.

In some embodiments, the activation information includes an activation code, a software authorization code, and/or a cloud secret encrypted using the public key. Using the activation information to activate the server includes using, by the agent, the activation code to activate the server, downloading, by the agent, software activated by the software authorization code, decrypting the software authorization code using the private key, and/or using the software authorization code to activate the software on the server, and/or using, by the agent, the cloud secret to register the server with a cloud service corresponding to the cloud secret. In other embodiments, the ledger further includes a cloud configuration encrypted using the public key and the cloud configuration identifies the cloud secret to be used to register the server with the cloud service. The agent further decrypts the cloud configuration using the private key and identifies, from the cloud configuration, the cloud secret to be used to register the server with the cloud service.

In some embodiments, the ledger includes two or more transactions with a first transaction added by the manufacturer. Each of the two or more transactions is encrypted with the public key and one or more of the transactions added after the first transaction includes information used by the agent to configure the server. In other embodiments, at least one of the one or more transactions added to the ledger after the first transaction is added by an entity different than the manufacturer and the entity possessed the server after the manufacturer and before the end user. In other embodiments, each of the two or more transactions in the ledger is by an entity that possessed the server when the transaction of the two or more transactions is added in the ledger.

In some embodiments, the agent is installed on the server by the manufacturer. In other embodiments, the operations further include adding, by the agent, a transaction in the ledger where the transaction includes identification of the end user, information about activating the server, and/or server provisioning completement. The agent encrypts the transaction by the agent using the public key.

A program product for activation of a remote server using activation information stored as transactions in a blockchain ledger is disclosed includes a non-transitory computer readable storage medium storing code. The code is configured to be executable by a processor to perform operations that include activating an agent on a server in response to the server being powered on for activation by an end user of the server. The agent includes a private key where the private key is paired with a public key by a manufacturer of the server. The public key is entered in a transaction of a ledger of a blockchain corresponding to the server where the ledger includes activation information for the server. The activation information encrypted using the public key. The operations include accessing the ledger by the agent, decrypting, by the agent, the activation information using the private key, and using, by the agent, the activation information to activate the server.

In some embodiments, the activation information includes an activation code, a software authorization code, and/or a cloud secret encrypted using the public key. Using the activation information to activate the server includes using, by the agent, the activation code to activate the server, downloading, by the agent, software activated by the software authorization code, decrypting the software authorization code using the private key, and/or using the software authorization code to activate the software on the server, and/or using, by the agent, the cloud secret to register the server with a cloud service corresponding to the cloud secret.

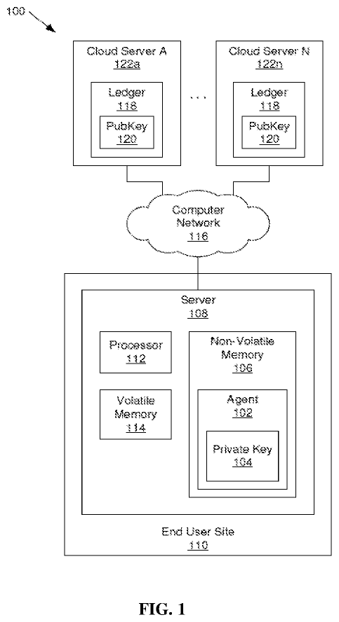

FIG. 1 is a schematic block diagram illustrating a system 100 for activating a remote server 108 using a ledger 118 of a blockchain, according to various embodiments. The system 100 includes an agent 102 that includes a private key 104 in non-volatile memory 106 of a server 108 that is located at an end user site 110. The server 108 includes at least one processor 112 and volatile memory 114. In some embodiments, the agent 102 is executable code stored in the non-volatile memory 106 that is executable by the processor 112. The server 108 is connected over a computer network 116 to one or more cloud servers 122, such as cloud servers A-N 122a-n. Each cloud server 122 includes a copy of a ledger 118 with a public key 120. The components of the system 100 are described in more detail below.

The server 108 includes and agent 102 for activation of the server 108 when the server 108 is powered on at an end user site 110. In some embodiments, the agent 102 includes code for self-activating upon power on of the server 108. In other embodiments, the code for activating the agent 102 activates the agent 102 after power on of the server 108 and after a user command, entry of a password, or other action subsequent to power on of the server 108. The agent 102 includes a private key 104 that is paired with a public key 120 by a manufacturer of the server 108. The public key 120 is stored in a ledger 118 of a blockchain accessible to the server 108 as well as the manufacturer and other hops, such as a distributor, a retailer, etc. along a supply chain between the manufacturer and the end user site 110.

The ledger 118 includes an activation code to activate the server 108, a cloud secret and/or a cloud configuration used to register the server 108 with a cloud service, authorization codes for authorizing software installation, a machine type and/or serial number of the server 108, an owner at a time a ledger transaction was made, and other information that may be used to activate the server 108 prior to utilization. The items in the ledger 118 are encrypted using the public key 120 and decrypted for use during activation of the server 108 using the private key 104. In some embodiments, the ledger 118 is a distributed ledger 118 of a blockchain where copies of the ledger 118 are located on one or more cloud servers 122 or other servers accessible to the server 108 and entities in the supply chain.

In some embodiments, the blockchain is a distributed ledger 118 with a growing list of blocks (e.g., transactions or records) that are securely linked together with cryptographic hashes. In some embodiments, a cryptographic hash function is designed to take a string of any length and as input and produce a fixed-length hash value. Each block contains a cryptographic hash of the previous block, a timestamp, and transaction data, such as the activation code, authorization codes, the cloud secret, etc. The timestamp, in some embodiments, provides proof that the transaction data existed when the block was created. Since each block contains information about the previous block, the blocks effectively form a chain with each additional block linking to the blocks before it. Thus, blockchain transactions are irreversible in that, once the blocks are recorded, the data in any given block cannot be altered retroactively without altering all the subsequent blocks. Thus, the blockchain with the ledger 118 provides an effective way protect data added at each hop of the supply chain.

Typically, a blockchain is managed by a peer-to-peer computer network, such as the cloud servers 122, for use as a distributed ledger, where nodes collectively adhere to a consensus algorithm protocol to add and validate new blocks. In some embodiments, each server 108 from a manufacturer has a separate blockchain with unique public and private keys 120, 104 specifically generated for the server 108 of the blockchain. The ledger 118 is reachable by each entity of the supply chain and the server 108 to enable addition of transactions to the ledger 118 and access of the transactions by the server 108 when activation of the server 108.

The agent 102, upon activation, accesses the ledger 118 and decrypts transactions in the ledger using the private key 104. The agent 102 then uses the activation code to activate the server, and uses authorization codes to download, install, and activate software, such as an operating system of the server 108 or other software of a software stack of the server 108. The agent 102, in some embodiments, uses a cloud configuration and/or a cloud secret to register the server 108 with a cloud service to enable the server 108 to access the cloud service. The agent 102, in some embodiments, enables a user, the agent 102, etc. to enter transactions in the ledger 118, such as server activation data, and the agent 102 encrypts the new transactions using the public key 120. The agent 102 is described in more detail below.

The agent 102 is installed by the manufacturer on the server 108 and loaded with the private key 104 of the blockchain applicable to the server 108. Having the agent 102 on the server 108 provides a way to activate the server 108 without requiring an authorized person to activate the server 108, which is advantageous over current methods of activating a server.

In some embodiments, server 108 includes a baseboard management controller (“BMC”—not shown) and the agent 102 is located in non-volatile memory 106 of the BMC or accessible to the BMC. A BMC, in some embodiments, provides access to the server 108 over a management network for various control functions, such as startup, shutdown, installation of software and firmware, upgrading of software and firmware, monitoring operation of the server 108, and the like. One embodiment of a BMC is a Lenovo® XClarity® Controller (“XCC”). In other embodiments, the server 108 includes a Unified Extensible Firmware Interface (“UEFI”), Basic Input/Output System (“BIOS”), etc. and the agent 102 is accessible in non-volatile memory 106 to the UEFI, BIOS, etc.

The server 108, in some embodiments, is an edge server, which is typically designed to be installed at an end user site 110 that is not a typical datacenter. In some embodiments, the edge server is designed to handle environments that are not environmentally controlled in an ideal way, such as in a factory, at a construction site, in a restaurant, in a closet that may get hot, etc. In other embodiments, the server 108 is a rack-mounted server at an end user site where the rack where the server 108 is mounted is not in a datacenter with personnel trained for working with computing equipment. In other embodiments, the server 108 is in a datacenter and use of the agent 102 allows a system administrator to spend less time working on server activation. One of skill in the art will recognize other uses and types for the server 108.

The server 108 includes one or more processors 112 and volatile memory 114 used by the processor 112. In some embodiments, the non-volatile memory 106 is firmware and the processor 112 executes the firmware prior to loading of the operating system of the server 108. In embodiments with a BMC in the server 108, the processor 112 may include a processor of the BMC. In some embodiments, the processor 112 downloads all or a portion of code of the agent 102 from the non-volatile memory 106 to the volatile memory 114 for execution by the processor 112. One of skill in the art will recognize other ways that the processor 112 and agent 102 interact to activate the server 108.

The server 108 is in communication with one or more cloud servers 122 with the ledger 118 over a computer network 116. In some embodiments, the computer network 116 is a management network. In some embodiments, the management network is a private network separate from a network used by the server 108 to communicate with a cloud service, clients, etc. In some embodiments where the computer network 116 is a management network, the server 108 and/or cloud servers 122 with ledgers 118 communicate with a management server that communicates with a BMC in the server 108 and controls the server 108. In other embodiments, one or more of the cloud servers 122 is a management server. In other embodiments, the computer network 116 is a public network or network other than a management network.

The computer network 116, in various embodiments, includes a LAN, a WAN, a fiber network, the Internet, or other wired cabled network. In other embodiments, the computer network 116 includes a wireless connection. In other embodiments, the computer network 116 is a combination of networks.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO)”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The cloud servers 122, in some embodiments, are peer-to-peer servers that communicate with each other to each maintain and update the ledger 118. Where the ledger 118 is updated with a transaction, the cloud servers 122 communicate to update the ledger 118 on the other cloud servers 122 so that each cloud server 122 has an equal copy of the ledger 118. In some embodiments, the cloud servers 122 are dedicated for use as blockchain servers. In some embodiments, the cloud servers 122 are provided by a service that offers blockchain solutions. In other embodiments, the cloud servers 122 are owned and/or managed by the manufacturer of the server 108. One of skill in the art will recognize other ways to implement a blockchain with a ledger 118 for each server 108 from the manufacturer.

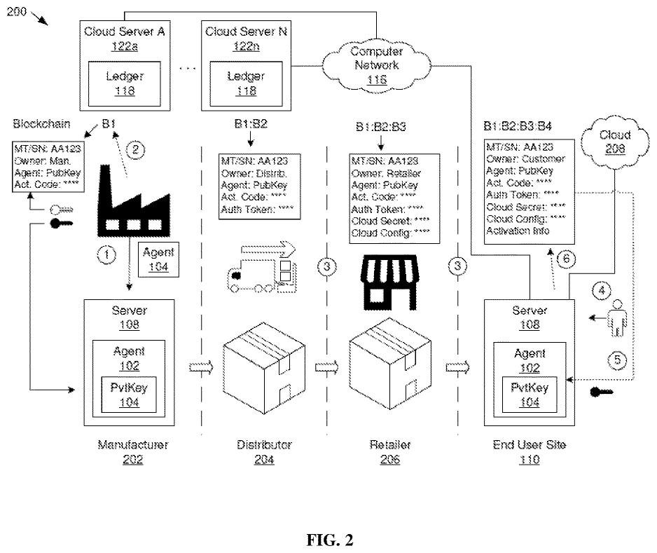

FIG. 2 is a schematic block diagram 200 illustrating steps for activating a remote server 108 using ledger 118 of a blockchain, according to various embodiments. The diagram 200 includes steps that start at the manufacturer 202 of the server 108. Step 1 includes initializing a blockchain specific to the server 108 and creating a paired public key 120 and private key 104. The manufacturer 202, in step 1, also installs the agent 102 on the server 108 and the private key 104 in the agent 102. In step 2 the manufacturer 202 communicates with the blockchain to load the public key 120 into the ledger 118 and creates a transaction in the ledger 118 that includes information to be used for activation of the server 108, such as the machine type, model number, serial number, etc. of the server 108. In other embodiments, the transaction includes an activation code provided by the manufacturer 202. While the diagram 200 of FIG. 2 includes the manufacturer 202 adding the activation code, in other embodiments the activation code is added to the ledger 118 in another step, such as by a distributor 204, by a retailer 206, by a user at the end user site 110, etc. The manufacturer 202 or cloud server 122 encrypts the transaction using the public key 120.

Step 3 includes shipping the server 108 to a next hop in the supply chain, such as to a distributor 204 and/or to a retailer 206. At one or more of the hops in the supply chain, an entity possessing the server 108 at a hop of the supply chain may access the ledger 118 and add additional information in a transaction on the ledger 118. In the diagram 200 of FIG. 2, the distributor 204 adds an authorization code for registration of software. For example, the distributor 204 may want a certain operating system (“OS”) installed on the server 108 and may include an authorization code in the ledger 118. The transaction by the distributor 204 is then encrypted using the public key 120. In other embodiments, the distributor 204 includes other information relevant to installing the OS, such as a uniform resource locator (“URL”) where the OS can be downloaded by the server 108 upon activation at the end user site 110.

The distributor 204 may also include other information relevant to installing the OS, such as a version of the OS to be installed. In other embodiments, the manufacturer 202 or a retailer 206 includes information in a transaction on the ledger 118 relevant to installing the OS. In other embodiments, a hop in the supply chain adds a software authorization code and/or installation information for other software to be installed in a software stack on the server 108. In some embodiments, at person at the server 108 is able to separately access and download any needed software authorization codes. In other embodiments, the manufacturer 202, distributor 204, retailer 206, etc. may include a software authorization code in a transaction on the ledger 118 for convenience. Each transaction added to the ledger 118 is encrypted using the public key 120 by the entity adding the transaction or by the cloud server 122 hosting the ledger 118. In the diagram of FIG. 2, the retailer 206 accesses the ledger 118 and adds a transaction that includes a cloud secret and/or a cloud configuration as well as any other relevant information about accessing a cloud service. The retailer 206 or cloud server 122 then encrypts the cloud secret, cloud configuration, etc. in the transaction using the public key 120.

Step 4 includes a user powering on the server 108 at the end user site 110, which triggers activation of the agent 102 on the server 108. In some embodiments, the user merely powering on the server 108 triggers activation of the agent 102. In other embodiments, powering on the server 108 plus another action of the user activates the agent 102. Step 5 includes the agent 102 accessing the ledger 118 and decrypting the transactions on the ledger 118 using the private key 104. The agent 102 then accesses the information in the transactions and starts by activating the server 108 using the activation code. The agent 102 then proceeds to download an OS and activate the OS using the authorization code. The agent 102 may then proceed with installation and activation of other software in a software stack of the server 108 using other software authorization codes. The agent 102 then uses the cloud secret, cloud configuration, etc. to download cloud software and register the server 108 with the cloud service 208 corresponding to the cloud configuration and cloud secret.

The cloud secret may be formatted in any suitable form, such as a password, token, 2-factor authentication, etc. Likewise, authorization codes, the activation code, etc. may be formatted in any suitable form convenient for secure authorization, activation, etc. One of skill in the art will recognize other tokens, passwords, codes, etc. that may be stored and encrypted in the ledger 118. The cloud secret, in some embodiments, includes user account information, a password, and/or other information useful in registering the server 108 with a cloud service.

Step 6 includes the agent 102 writing a transaction to the ledger 118 that includes activation information. In various examples, the transaction may include a date of activation, configuration information of the server 108, software, a cloud service, or any other information relevant to activation of the server 108. The agent 102 or cloud server 122 encrypts the transaction using the public key 120. Subsequent to activation, other transactions may be added to the ledger 118, such as switching from one cloud service to another, adding more software, etc. In some embodiments, information is added to the ledger 118 in various transactions that may not be used. For example, the distributor 204 may add a cloud secret and a cloud configuration to the ledger 118 for one cloud service, but when the server 108 is sold to a retailer 206, the retailer 206 may add another transaction with a different cloud secret and updated cloud configuration pointing to another cloud service and the agent 102, in some embodiments, is configured to use cloud configuration information from a most recent transaction.

The diagram 200 of FIG. 2 is representative of one simple supply chain and transactions that may occur along hops in the supply chain and the associated information that is added the ledger 118 by the manufacturer 202, the distributor 204, the retailer 206, and the agent 102. Other supply chains with other servers 108 will have different hops and different transactions with different information encrypted by a public key 120.

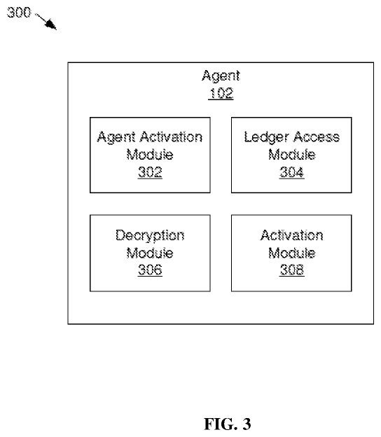

FIG. 3 is a schematic block diagram illustrating an apparatus 300 for activating a remote server 108 using a ledger 118 of a blockchain, according to various embodiments. The apparatus 300 includes an agent 102 with an agent activation module 302, a ledger access module 304, a decryption module 306, and an activation module 308, with are described below. In some embodiments, all or a portion of the apparatus 300 is implemented as executable code that is executable by a processor and stored on computer readable storage media. The computer readable storage media is non-transitory. In other embodiments, all or a portion of the apparatus 300 is implemented using hardware circuits and/or a programmable hardware device.

The apparatus 300 includes an agent activation module 302 configured to activate an agent 102 on a server 108 in response to the server 108 being powered on for activation by an end user of the server 108. In some embodiments, the agent activation module 302 is configured to activate the server 108 in response to power on of the server 108 and another action, such as the user approving activating the agent 102, the user inputting a password, or other relevant action. The agent 102 includes a private key 104 where, in some embodiments, the private key 104 is paired with a public key 120 by a manufacturer 202 of the server 108.

The public key 120, in some embodiments, is entered in a transaction of a ledger 118 of a blockchain corresponding to the server 108, the ledger 118 includes activation information for the server 108. The activation information is encrypted using the public key 120. The activation information may include an activation code used to activate the server 108, a software authorization code and other software information used to download and register the software, and/or a cloud secret and cloud configuration used to register the server 108 with a cloud service. One of skill in the art will recognize other types of activation information.

The apparatus 300 includes a ledger access module 304 configured to access the ledger 118 by the agent 102. In some embodiments, the agent 102 accesses the ledger 118 using a communication portal of the server 108 to access a computer network 116 connected to a cloud server 122 or other server hosting the ledger 118. In some embodiments, the computer network 116 is a management network. In some embodiments, the ledger 118 and associated blockchain are associated with the server 108. In some embodiments, the blockchain and ledger 118 are created specifically for the server 108.

The apparatus 300 includes a decryption module 306 is configured to decrypt the activation information using the private key 104. In some embodiments, the ledger access module 304 is configured to download the encrypted transactions from the ledger 118 that include the activation information and the decryption module 306 is configured to decrypt the encrypted transactions using the private key 104 at the server 108. In other embodiments, the decryption module 306 is configured to use the private key 104 to decrypt the transactions including the activation information at the ledger 118 and then the ledger access module 304 is configured to download the decrypted transactions to the server 108 or to merely read the decrypted transactions to access the activation information. One of skill in the art will recognize other ways that the ledger access module 304 and the decryption module 306 access the ledger 118, decrypt transactions with the activation information and then access the activation information.

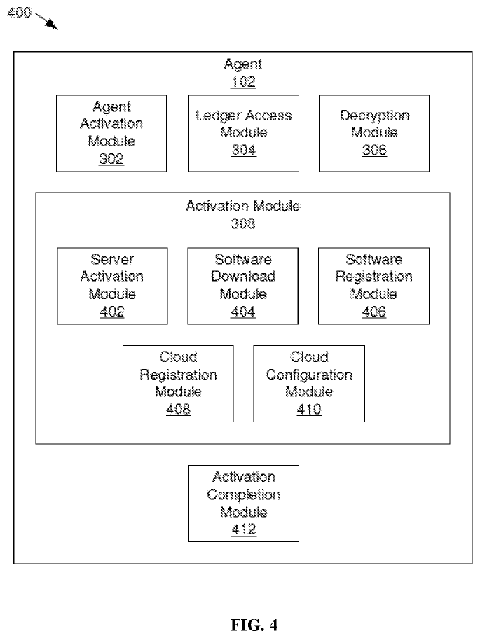

The apparatus 300 includes an activation module 308 configured to use the activation information to activate the server 108. In some examples, the activation module 308 uses an activation code to activate the server 108, uses an authorization code to register software, uses a cloud secret to register the server 108 with a cloud service, etc. Various server activation activities of the activation module 308 are described below with regard to the apparatus 400 of FIG. 4.

FIG. 4 is a schematic block diagram illustrating another apparatus for activating a remote server 108 using a ledger 118 of a blockchain, according to various embodiments. The apparatus 400 includes an agent 102 with an agent activation module 302, a ledger access module 304, a decryption module 306, and an activation module 308, which are substantially similar to those described above in relation to the apparatus 300 of FIG. 3. The activation module 308 includes a server activation module 402, a software download module 404, a software registration module 406, a cloud registration module 408, and/or a cloud configuration module 410, and/or the apparatus 400 includes an activation completion module 412, which are described below.

In some embodiments, the activation module 308 includes a server activation module 402 configured to use the activate the server 108 using an activation code from the ledger 118. The activation code is decrypted using the private key 104 by the decryption module 306. In some embodiments, the server activation module 402 uses server information stored in a transaction with the activation code or in a transaction from the manufacturer 202 to activate the server 108. In some embodiments, the transaction with the activation code is from an entity different than the manufacturer 202. In some examples, the server 108 is locked with internal firmware and the server activation module 402 provides the activation code to unlock the server 108. In other embodiments, the agent 102 uses information such as a machine type, a server serial number, and other relevant information along with the activation code to communicate with the manufacturer 202 or other entity controlling unlocking of the server and the manufacturer 202/other entity provides information, such as a token, a key, etc. to activate the server 108. One of skill in the art will recognize other ways for the server activation module 402 to use the activation code to activate the server 108.

The activation module 308 includes, in some embodiments, a software download module 404 configured to download software to be installed on the server 108 and/or a software registration module 406 configured to uses the software authorization code to activate the software on the server 108. The software may include an operating system, cloud access software, vendor software, or other software to be installed in a software stack as designated by entities of one or more hops of the supply chain.

A transaction with a software authorization code, in some embodiments, includes software information such as a link to where the software is located or other information and/or instructions to download and install software on the server 108. The decryption module 306 decrypts, using the private key 104, the transaction(s) with the software authorization code and/or software information. In some embodiments, the software download module 404 downloads and installs the software and the software registration module 406 registers/activates the software using the authorization code. In other embodiments, the software registration module 406 is configured to communicate with a software vendor to provide the authorization code to the vendor before the software download module 404 downloads and installs the software. One of skill in the art will recognize other software and associated authorization codes to be downloaded, installed, and registered by the software download module 404 and the software registration module 406.

The apparatus 400, in some embodiments, includes a cloud registration module 408 configured to use a cloud secret to register the server 108 with a cloud service corresponding to the cloud secret. In some embodiments, the decryption module 306 uses the private key 104 to decrypt a transaction in the ledger 118 with the cloud secret. In some embodiments, the cloud registration module 408 is configured to download cloud service software that interacts with the cloud service. Registering the server 108 with the cloud service, in some embodiments, authorizes the server 108 to access and use the cloud service for executing workloads, for storing data, or for other typical cloud functions.

In some embodiments, the apparatus 400 includes a cloud configuration module 410 configured to access the cloud configuration that identifies the cloud secret to be used to register the server 108 with the cloud service. In the embodiment, a transaction on the ledger 118 includes the cloud configuration and the decryption module 306 uses the private key 104 to decrypt the cloud configuration and the ledger access module 304 accesses and/or downloads the decrypted cloud configuration. In some embodiments, the cloud configuration identifies the cloud service, includes a link to the cloud service, includes a link for downloading cloud service software, or the like. In some embodiments, the cloud registration module 408 and the cloud configuration module 410 work together to use the cloud configuration and the cloud secret to register the server 108 with the cloud service. In some embodiments, the ledger 118 includes multiple cloud secrets and the cloud configuration directs the cloud registration module 408 as to which cloud secret to use to register the server 108 with a most recent cloud service.

In some embodiments, the apparatus 400 includes an activation completion module 412 configured to add a transaction in the ledger 118 where the transaction includes identification of the end user, information about activating the server 108, server provisioning completement, and/or other information relevant to the activation of the server 108. The activation information includes an activation record that indicates that the server 108 has been activated. In addition, the activation information may include other details regarding provisioning completement, such as what software was installed, which cloud service was registered, or other steps taken during activation of the server 108. In some embodiments, the activation completion module 412 encrypts or requests encryption of the transaction the public key 120.

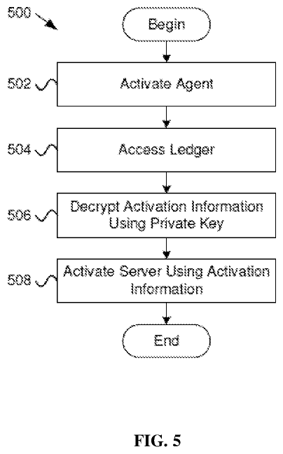

FIG. 5 is a schematic flow chart diagram illustrating a method 500 for activating a remote server 108 using a ledger 118 of a blockchain, according to various embodiments. The method 500 begins and activates 502 an agent 102 on a server 108 in response to the server 108 being powered on for activation by an end user of the server 108. In some embodiments, the method 500 activates the agent 102 in response to the server 108 being powered on and another action, such as inputting a password, inputting a code, selecting an action, etc. The agent 102 includes a private key 104 where the private key 104 is paired with a public key 120 by a manufacturer 202 of the server 108. The public key 120 is entered in a transaction of a ledger 118 of a blockchain corresponding to the server 108. The ledger 118 includes activation information for the server 108 where the activation information is encrypted using the public key 120.

The method 500 includes accessing 504 the ledger 118 by the agent 102, decrypting 506, by the agent 102, the activation information using the private key 104, and using 508, by the agent 102, the activation information to activate the server 108, and the method 500 ends. In various embodiments, all or a portion of the method 500 is implemented using the agent activation module 302, the ledger access module 304, the decryption module 306, and/or the activation module 308.

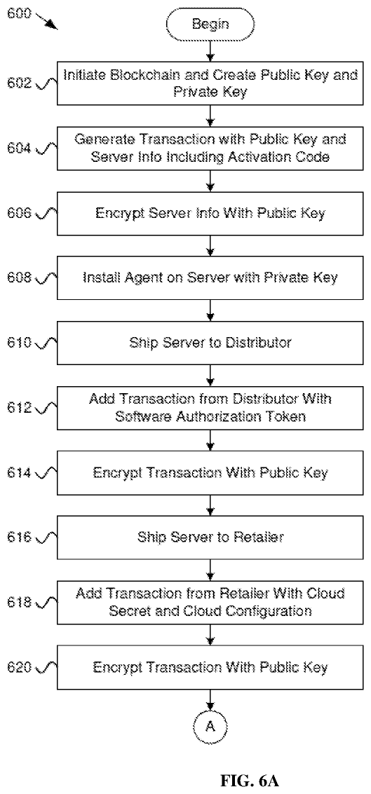

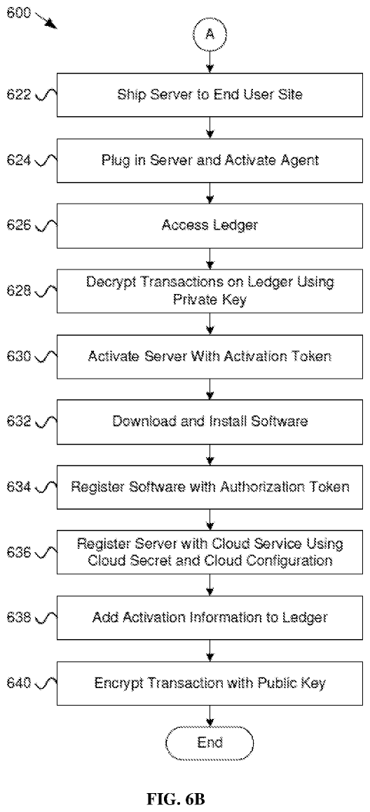

FIG. 6A is a first part and FIG. 6B is a second part of a schematic flow chart diagram illustrating another method 600 for activating a remote server 108 using a ledger 118 of a blockchain, according to various embodiments. The method 600 is one possible method using the embodiments described herein and may vary based a supply chain of a server 108. The method 600 begins and the manufacturer 202 of the server 108 initiates 602 a blockchain specific to a server 108 manufactured by the manufacturer 202 and creates 602 a public key 120 and a private key 104. The blockchain includes a ledger 118. The manufacturer 202 generates 604 a transaction in a ledger 118 with the public key 120 and the server information including an activation code and then encrypts 606 the server information using the public key 120. The manufacturer 202 installs 608 the agent 102 on the server 108 and ships 610 the server 108 to a distributor 204.

The distributor 204 adds 612 a transaction to the ledger 118 that includes a software authorization code and encrypts 614 the transaction with the public key 120 and then ships 616 the server 108 to a retailer 206. The software authorization code is for registering software installed on the server 108 with a vendor of the software. The software may be an operating system or other software to be added to a software stack of the server 108. The retailer 206 adds 618 a transaction to the ledger 118 with a cloud secret and/or a cloud configuration. The cloud secret is used to register the server 108 with a cloud server and the cloud configuration includes information about the cloud service to be used and other relevant information regarding the cloud service. The retailer 206 encrypts 620 the transaction with the public key 120 and then ships 622 the server 108 to an end user at the end user site 110.

The end user plugs 624 in the server 108, and the method 600 activates the agent 102. The method 600 accesses 626 the ledger 118 and decrypts 628 transactions on the ledger 118 using the private key 104. The method 600 activates 630 the server 108 using the activation code decrypted from the ledger 118 and downloads 632 and installs software corresponding to the software activation code and registers 634 the software with the software activation code. The method 600 registers 636 the server 108 using the cloud secret and information from the cloud configuration. The method 600 adds 638 a transaction to the ledger 118 that includes activation information and encrypts 640 the transaction with the public key 120, and the method 600 ends. The activation information includes an activation record that indicates that the server has been activated. In addition, the activation information may include other details regarding activation of the servers, such as what software was installed, which cloud service was registered, etc. In various embodiments, portions of the method 600 are implemented using the agent activation module 302, the ledger access module 304, the decryption module 306, the activation module 308 with the server activation module 402, the software download module 404, the software registration module 406, the cloud registration module 408, and/or the cloud configuration module 410, and/or the activation completion module 412.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
activating an agent on a server in response to the server being powered on for activation by an end user of the server, the agent comprising a private key, the private key paired with a public key by a manufacturer of the server, the public key entered in a transaction of a ledger of a blockchain corresponding to the server, the ledger comprising activation information for the server, the activation information encrypted using the public key;
accessing the ledger by the agent;
decrypting, by the agent, the activation information using the private key; and
using, by the agent, the activation information to activate the server.

2. The method of claim 1, wherein the activation information comprises an activation code and/or a cloud secret encrypted using the public key, wherein using the activation information to activate the server comprises using, by the agent, the activation code to activate the server, and/or using, by the agent, the cloud secret to register the server with a cloud service corresponding to the cloud secret.

3. The method of claim 2, wherein the ledger further comprises a cloud configuration encrypted using the public key and wherein the cloud configuration identifies the cloud secret to be used to register the server with the cloud service.

4. The method of claim 3, wherein the agent further decrypts the cloud configuration using the private key and identifies, from the cloud configuration, the cloud secret to be used to register the server with the cloud service.

5. The method of claim 2, wherein the activation information further comprises a software authorization code encrypted by the public key and wherein the agent downloads software activated by the software authorization code, decrypts the software authorization code using the private key, and uses the software authorization code to activate the software on the server.

6. The method of claim 1, wherein the ledger comprises two or more transactions with a first transaction added by the manufacturer, wherein each of the two or more transactions is encrypted with the public key and one or more of the transactions added after the first transaction comprises information used by the agent to configure the server.

7. The method of claim 6, wherein at least one of the one or more transactions added to the ledger after the first transaction is added by an entity different than the manufacturer and the entity possessed the server after the manufacturer and before the end user.

8. The method of claim 6, wherein each of the two or more transactions in the ledger is by an entity that possessed the server when the transaction of the two or more transactions is added in the ledger.

9. The method of claim 1, wherein the agent is installed on the server by the manufacturer.

10. The method of claim 1, further comprising adding, by the agent, a transaction in the ledger, the transaction comprising identification of the end user, information about activating the server, and/or server provisioning completement, wherein the agent encrypts the transaction by the agent using the public key.

11. A server comprising:
a processor; and
non-transitory computer readable storage media storing code, the code comprising an agent, the code of the agent being executable by the processor to perform operations comprising:
activating the agent in response to the server being powered on for activation by an end user of the server, the agent comprising a private key, the private key paired with a public key by a manufacturer of the server, the public key entered in a transaction of a ledger of a blockchain corresponding to the server, the ledger comprising activation information for the server, the activation information encrypted using the public key;
accessing the ledger by the agent;
decrypting, by the agent, the activation information using the private key; and
using, by the agent, the activation information to activate the server.

12. The server of claim 11, wherein the activation information comprises an activation code, a software authorization code, and/or a cloud secret encrypted using the public key, wherein using the activation information to activate the server comprises:
using, by the agent, the activation code to activate the server;
downloading, by the agent, software activated by the software authorization code, decrypting the software authorization code using the private key, and/or using the software authorization code to activate the software on the server; and/or
using, by the agent, the cloud secret to register the server with a cloud service corresponding to the cloud secret.

13. The server of claim 12, wherein the ledger further comprises a cloud configuration encrypted using the public key and wherein the cloud configuration identifies the cloud secret to be used to register the server with the cloud service, wherein the agent further decrypts the cloud configuration using the private key and identifies, from the cloud configuration, the cloud secret to be used to register the server with the cloud service.

14. The server of claim 11, wherein the ledger comprises two or more transactions with a first transaction added by the manufacturer, wherein each of the two or more transactions is encrypted with the public key and one or more of the transactions added after the first transaction comprises information used by the agent to configure the server.

15. The server of claim 14, wherein at least one of the one or more transactions added to the ledger after the first transaction is added by an entity different than the manufacturer and the entity possessed the server after the manufacturer and before the end user.

16. The server of claim 14, wherein each of the two or more transactions in the ledger is by an entity that possessed the server when the transaction of the two or more transactions is added in the ledger.

17. The server of claim 11, wherein the agent is installed on the server by the manufacturer.

18. The server of claim 11, the operations further comprising adding, by the agent, a transaction in the ledger, the transaction comprising identification of the end user, information about activating the server, and/or server provisioning completement, wherein the agent encrypts the transaction by the agent using the public key.

19. A program product comprising a non-transitory computer readable storage medium storing code, the code being configured to be executable by a processor to perform operations comprising:
activating an agent on a server in response to the server being powered on for activation by an end user of the server, the agent comprising a private key, the private key paired with a public key by a manufacturer of the server, the public key entered in a transaction of a ledger of a blockchain corresponding to the server, the ledger comprising activation information for the server, the activation information encrypted using the public key;
accessing the ledger by the agent;
decrypting, by the agent, the activation information using the private key; and
using, by the agent, the activation information to activate the server.

20. The program product of claim 19, wherein the activation information comprises an activation code, a software authorization code, and/or a cloud secret encrypted using the public key, wherein using the activation information to activate the server comprises:
using, by the agent, the activation code to activate the server;
downloading, by the agent, software activated by the software authorization code, decrypting the software authorization code using the private key, and/or using the software authorization code to activate the software on the server; and/or
using, by the agent, the cloud secret to register the server with a cloud service corresponding to the cloud secret.
